(19) United States
(12) Patent Application Publication
(10) Pub. No.: US 2008/0271609 A1
(43) Pub. Date: Nov. 6, 2008

(54) Auto-Stir and Tilt Cooking Appliance

(76) Inventors: Richard Charles Pahl, St. Petersburg, FL (US); Gregory Jarrett Walsh, Essex Jct, VT (US)

Correspondence Address: DOROTHY S. MORSE, 515 PARK DRIVE, NW, BRADENTON, FL, 34209, US

(21) Appl. No.: 12/115,539

(22) Filed: May 5, 2008

Related U.S. Application Data
(60) Provisional application No. 60/927,834, filed on May 5, 2007.

(51) Int. Cl. A47J 27/00; G05B 15/00

(52) U.S. Cl. 99/348; 700/275

(57) ABSTRACT

An electric cooking appliance that has a removable cooking pot, positive locking between the cooking pot and a base configured for heating food in the pot, with the heating base also being configured for tilting the cooking pot up to an approximate forty-five degree angle from its original position. The appliance also includes a collar configured for upward positioning beyond the top edge of the cooking pot and a stirring motor arm with at least one connected stirring blade that extends into the cooking pot when the pot is in its usable position and locked onto the base. The collar tapers inwardly over the lateral edges of the stirring blade to reduce splashing and spilling in both level and tilted orientations. Stirring speed and the amount of tilt are adjustable. Further, applications can include, but are not limited to, the cooking of stir fry dishes, fudge, soups, vegetables, and stews.

### CROSS-REFERENCES TO RELATED APPLICATIONS

This application relates to a U.S. provisional application having the title of “Auto-Stir and Tilt Cooking Appliance”, which was given the Ser. No. 60/927,834 and was filed on May 5, 2007 by the same inventors herein. A Disclosure Document Deposit Request for similar subject matter was also mailed to the U.S. Patent and Trademark Office on May 2, 2007 by one of the inventors herein, Richard C. Pahl, using U.S. Post Office “Express Mail Service to Addressee”. The title used in the papers accompanying the Disclosure Document Deposit Request was “Auto-Stir and Tilt”. The applicants herein request all benefit possible from these documents previously on record with the U.S. Patent and Trademark Office.

### BACKGROUND

1. Field of the Invention

This invention relates to the field of cooking pots and mixers, specifically to an electrical cooking appliance that has a removable cooking pot, positive locking between the cooking pot and a base capable of heating food in the pot, the heating base also configured for tilting the cooking pot up to an approximate forty-five degree angle from its original position, a splash and spill reducing collar configured for association with the top edge of the cooking pot, and a stirring motor arm with at least one connected stirring blade that extends into the cooking pot when the pot is in its usable position and locked onto the base. The stirring blade configuration preferably has one end reaching food close to the sides of the cooking pot and a second end positioned more centrally within the pot. Applications can include, but are not limited to. The cooking of stir fry dishes, fudge, soups, vegetables, and stews.

2. Description of the Related Art

Many recipes call for intermittent or continuous stirring of food while it is being cooked. If a sufficient amount of stirring is not performed, the cooked food will burn, have a less appetizing taste, become unevenly thickened, have an undesirable texture, and/or stick to the pot or pan used for cooking it. Further, sometimes a pot or pan must be tilted by a cook to temporarily remove it from the heat source to prevent overcooking, slow down cooking, add ingredients, obtain mixing leverage, and/or for easier removal of food from the pot or pan. Prior art devices are inadequate for the combined heating and stirring of coarse-textured and thickened foods, such as stews and chunky soups, fudge, and stir fry dishes prepared using coarse chopped vegetables, meat, and/or seafood pieces. Current kitchen mixers typically stir food, but do not coo it. Heated serving trays and chafing dishes will maintain food at elevated temperatures, but do not stir it. Further, the use of cooking pots or pans on a stove typically requires manual stirring several times before cooking is complete, which during the preparation of some foods allows little time for a cook to accomplish other tasks. Chemical and medical laboratories employ heated stirrers having a rotating bar magnet to mix and heat liquids. Further, some laboratory stirring tables using bar magnets have a tilt option. A magnetic wand is typically used to lower the bar magnet into a flat-bottomed vessel sitting upon a heated base, whereby after removal of the wand stirring can commence. The magnet stays centered within the vessel, and draws a vortex from above immediately above it to cause the vertical intermixing of liquids originally from diverse locations within the vessel. However, thickened and coarsely chopped foods that do not eventually dissolve, as laboratory chemical most often do, would be drawn down by the vortex toward the rotating magnet and could seriously interfere with effective magnet operation, and perhaps result in improperly cooked food. In contrast, the present invention provides an all-in-one unit that has a cooking pot locked into a heating base which can provide tilting for the pot up to an approximate forth-five degree angle for any of the above-mentioned purposes. Further, the present invention includes a mixing arm pivotally attached to the base, which normally supports at leas one stirring blade that is configured to stir/move food adjacent to the interior sides of the cooking pot, in addition to reaching more centrally located food in the cooking pot. A collar minimizes splashing and assists in preventing food spilling out of the cooking pot when it is in a tilted orientation. No other cooking appliance is known that has the same structure, functions in the same manner, or provides all of the advantages of the present invention.

### BRIEF SUMMARY OF THE INVENTION

The primary object of this invention to provide a self-contained, adjustably tiltable, counter-top or table-top supported, microprocessor-controlled, and auto-stirring cooking appliance with a multi-speed or variable speed stirring motor for cooking and mixing of food in a stable and securely positioned cooking pot. Another object f this invention is to provide an auto-stirring and tiltable cooking appliance that promotes safe use by having a tilt mechanism actuated without the operator turning over or lifting up the heating base. It is a further object of this invention to provide an auto-stirring and tiltable cooking appliance that has its cooking pot positively locked into its heating base. It is also an object of this invention to provide an auto-stirring and tiltable cooking appliance that has dishwasher-safe and removable components. It is a further object of this invention to provide an auto-stirring and tiltable cooking appliance with stirring blades that can be easily and promptly removed for cleaning. It is also an object of this invention to provide an auto-stirring and tiltable cooking appliance with a heating base that can accommodate and securely lock into place different sizes of cooking pots.

The present invention, when properly made and used, will provide an all-on-one unit that has a cooking pot locked into a heating base so that the cooking pot can be tilted up to an approximate forty-five degree angle while food in being heated and stirred therein without spillage or splashing of food out of said cooking pot. Further, the present invention includes a mixing arm pivotally attached to the heating base which rotationally supports at least one stirring blade that is configured to stir/move food adjacent to the sides of the cooking pot while it is also secured to the heating base, in addition to stirring and/or moving food more centrally located in the cooking pot. A collar upwardly depending from the top edge of the cooking pot on the heating base is positioned over a portion of the rotating stirring blade and minimizes splashing and spilling of food, while generally assisting in the containment of food being cooked and stirred within the cooking pot, particularly when it is in a tilted orientation. When a different size of cooking pot is secured to the heating base, a different collar having a complementary configuration to the new cooking pot is also typically needed. Stirring blades can be spring-loaded, and different configurations of blade can be used in differing applications. Additionally, the stirring blade for stiff fudge ingredients may need to have a sturdier construction than a stirring blade for soups. Further, a torque limiter could be included as a part of the present invention to protect the motor should the stirring blade unexpectedly jam or otherwise cease movement while the motor continues to operate. In addition, and internal or external tilt mechanism can be used. It is also contemplated for the stirring motor arm to be programmable via a microprocessor for intermittent stirring, and/or increased frequency of stirring at the end of food preparation when the burning and/or sticking of food being cooked is most likely to occur. Also, heating and stirring functions can be programmed for a delayed start, and/or to cease at a pre-determined time after food cooking begins, either at the same time or independently from one another. Typically, the cooking pot has insulated handles and the front portion of the heating base has a widened blunt area that provides stability when the heating base is in a tilted orientation. No other cooking appliance is known that has the same structure, functions in the same manner, or provides all of the advantages of the present invention.

The description herein provides preferred embodiments of the present invention but should not be construed as limiting its scope. For example, variations in the height dimension, thickness dimension, and heat-resistant materials used for the collars; the configurations of the stirring blades used and the materials from which they are made; the number and configuration of the handles used on the cooking pots; the type of insulated materials from which the handles are made; the configuration of the tilting mechanism; the materials from which the tilting mechanism is made; and whether the tilting mechanism is internally-housed or externally-housed, other than those shown and described herein, may be incorporated into the present invention. Thus the scope of the present invention should be determined by the appended claims and their legal equivalents, rather than being limited to the examples given.

### BRIEF DESCRIPTION OF THE DRAWINGS

FIG. 1 is a top view of a cooking pot in the most preferred embodiment of the present invention locked onto a heating base and in a non-tilted orientation.

FIG. 2 is a top view of the cooking pot in the most preferred embodiment of the present invention with an adjacent stirring motor arm pivotally rotated in an upward direction away from the cooking pot.

FIG. 3 is a side view of the stirring blade in the most preferred embodiment of the present invention having one end configured and positioned for mixing cooked food close to the interior side surfaces of the cooking pot and another end configured and positioned for mixing cooked food more centrally within the cooking pot.

FIG. 4 is a perspective view of the collar upwardly-extending beyond the top edge of the cooking pot in the most preferred embodiment of the present invention to prevent the splashing and spilling of food in the cooking pot while it is being cooked and stirred in both tilted and non-tilted (substantially level) orientations.

FIG. 5 is a front view of the stirring blade in the most preferred embodiment of the present invention attached to the stirring motor arm, with both raised upwardly beyond the top edge of the cooking pot.

FIG. 6 is a top view of the stirring blade in the most preferred embodiment of the present invention attached to the stirring motor arm and located in a substantially horizontally-extending position over a non-tilted cooking pot, whereby one end of the stirring blade becomes positioned for mixing food close to the sides of the cooking pot and the other end becomes positioned for mixing food more centrally located within the cooking pot.

FIG. 7 is a top view of the stirring motor arm in the most preferred embodiment of the present invention having an attached stirring blade and located in a substantially horizontally-extending position over a non-tilted cooking pot which has a collar upwardly-extending beyond its top edge, with the upper edge of the collar tapering inwardly over the lateral portions of the stirring blade.

FIG. 8 is a bottom view of the heating base in the most preferred embodiment of the present invention having an external tilt mechanism in an extended position.

FIG. 9 is a side view of the cooking pot in the most preferred embodiment of the present invention in locked association with a heating base, a collar upwardly extending beyond the cooking pot's top edge, the stirring motor arm extending in a substantially horizontal position over the cooking pot and the heating base and cooking pot each in a tilted orientation.

FIG. 10 is a side view of the cooking pot in the most preferred embodiment of the present invention in locked association with a heating base, a collar upwardly extending beyond the cooking pot s top edge, the stirring motor arm extending in a substantially horizontal position over the cooking pot, and the heating base and cooking pot both in non-tilted orientations.

### DETAILED DESCRIPTION OF PREFERRED EMBODIMENTS

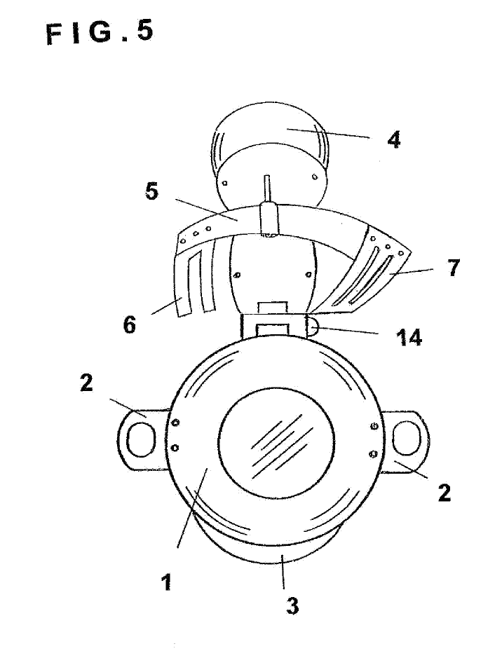

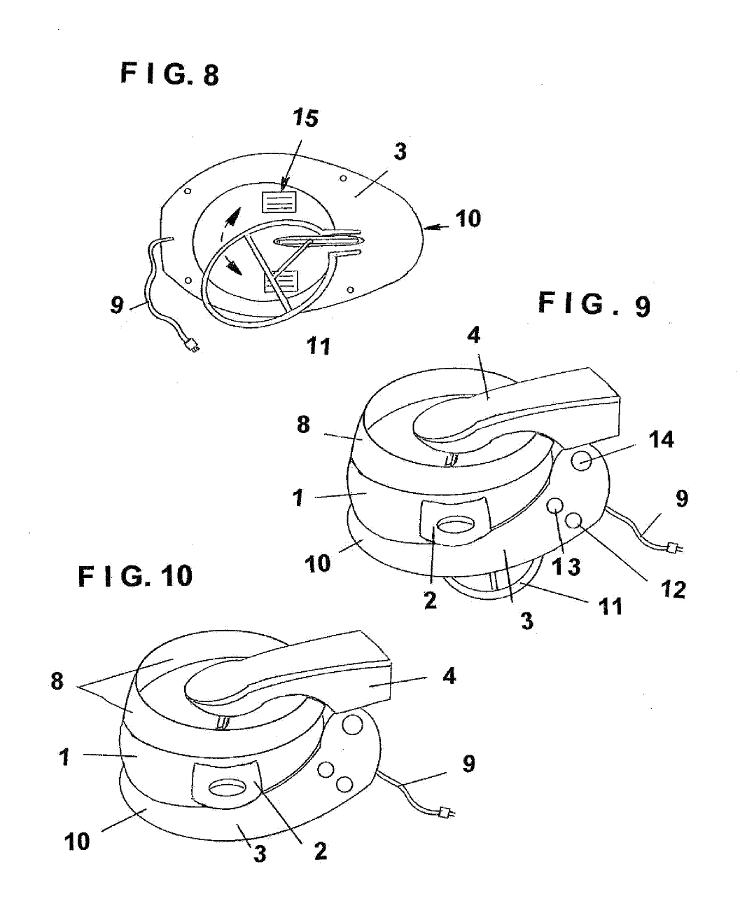

The present invention provides an all-in-one cooking applicant that comprises a cooking pot 1 locked into a heating base 3, which can provide tilting for cooking pot 1 up to an approximate forty-five degree angle. The appliance is self-contained, microprocessor controlled, has a multi-speed or variable speed stirring motor within stirring motor arm 4, and can be adjustably tilted for many convenient countertop uses. Preferred applications, although not limited thereto, include stir fry dishes, fudge, soups, vegetables, and stews. The automatic stirring capability of the present invention prevents burning and sticking of food while it is cooking. Less attention from the operator is required, with additional benefits including better food flavor and enhanced ease of clean-up. Thus, as dictated by the experience or notes in a recipe, an operator (not shown) of the present invention can optionally remain by cooking pot 1 to closely watch food being heated in it and properly time the addition of other ingredients while automatic stirring takes place, or the operator may have the option to walk away from cooking pot 1 and perform other tasks during time that would have been otherwise devoted to manual stirring. For safety reasons, the tilting capability of the present invention is adjustable without an operator having to turn over pr lift up base 3, so that adjustments in the orientation of cooking pot 1 can be made after heating has begin. Power for the present invention appliance is preferably provided to the stirring motor and microprocessor via 120-volt or 220-volt alternating current. It is also contemplated for removable components of the present invention, such as collar 8, stirring blade 5, and cooking pot 1 to be dishwasher safe. In addition, some embodiments may have a power cord that is removable from heating base 3 so that other components can be safely washed by hand, such as stirring motor arm 4. Further, the present invention includes a stirring motor arm 4 pivotally attached to a heating base 3, a stirring blade rotatably supported within the bottom surface of the horizontally-extending portion of the stirring motor arm 4, and the stirring blade 5 configured to stir/move food adjacent to the interior side surfaces of cooking pot 1, in addition to reaching more centrally located food (not shown) within cooking pot 1. A collar 8 attached to the top edge of cooking pot 1 minimizes the splashing of food out of cooking pot 1 when it is being stirred by rotating blade 5, and assists in generally containing food within cooking pot 1 when cooking pot 1 is in any tilted orientation. When a different size of cooking pot 1 is secured to heating base 3, a different collar 8 having a configuration complementary to the new cooking pot 1 is typically also required. Stirring blades 5 can be spring-loaded, and different configurations of blade mixing members (such as but not limited to the blade mixing members 6 and 7 shown in FIGS. 3 and 5) can be use in differing food preparation applications. Further, although not shown, a torque limited could be included as a part of the present invention to protect the stirring motor should the movement of blade 5 unexpectedly cease while the stirring motor continues to operate. In addition, an internal or external tilt mechanism can be used, such as but not limited to the external tilt mechanism 11 shown in FIGS. 8 and 9. It is contemplated for the stirring motor arm 4 to be programmable to provide intermittent stirring, and/or progressively increased stirring near the end of food preparation when the burning of food being cooked is most likely to occur. Also, heating and stirring can be programmed for a delayed start by both at the same time, staggered starts of one before the other, and/or cessation at a pre-determined time after food cooking begins, either at the same time or at times independent from one another. Typically, cooking pot 1 has insulated handles 2, and the front portion of heating base 3 has a widened blunt area 10 that provides enhanced stability when heating base 3 and cooking pot 1 are in tilted orientations.

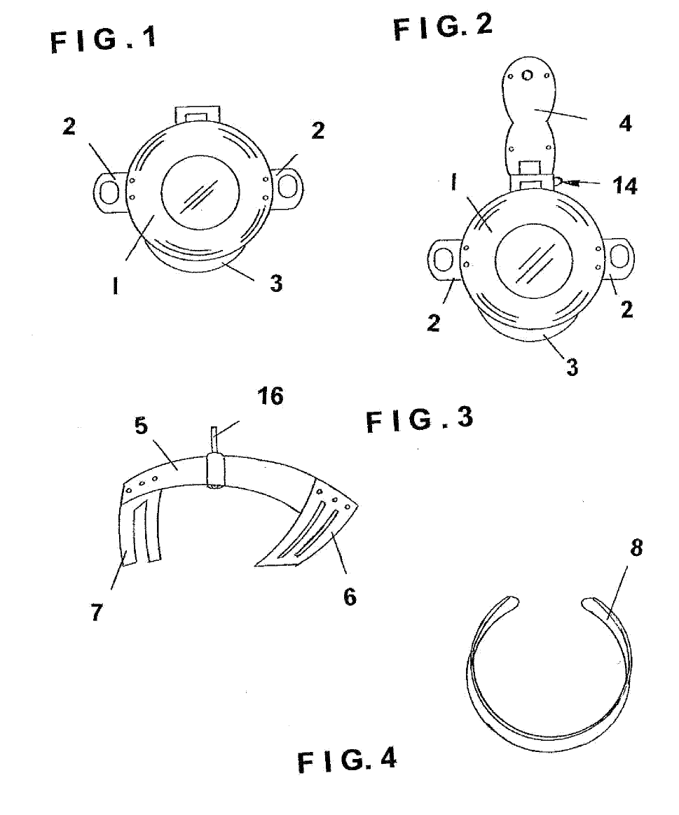

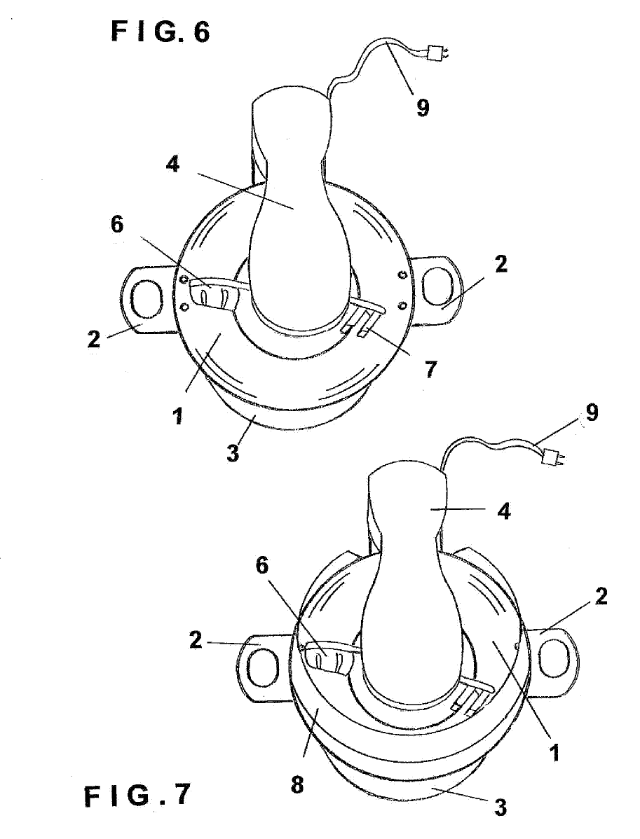

FIG. 1 is a top view of a cooking pot 1 in the most preferred embodiment of the present invention locked onto a heating base 3 and in a non-tilted orientation. FIG. 2 is a top view of the cooking pot 1 in the most preferred embodiment of the present invention with an adjacent stirring motor arm 4 pivotally rotated in an upward direction away from the cooking pot 1. FIG. 3 is a side view of the stirring blade 5 in the most preferred embodiment of the present invention having one end 7 configured and positioned for mixing cooked food close to the interior side surfaces of the cooking pot 1 and another end 6 configured and positioned for mixing cooked food more centrally within the cooking pot 1. FIG. 3 also shows the drive shaft 16 used to connect stirring blade 5 to stirring motor arm 4. FIG. 4 is a perspective view of the collar 8 upwardly-extending beyond the top edge of the cooking pot 1 in the most preferred embodiment of the present invention to prevent the splashing and spilling of food (not shown) in the cooking pot 1 while it is being cooked and stirred in both tilted and non-tilted (substantially level) orientations. FIG. 5 is a front view of the stirring blade 5 in the most preferred embodiment of the present invention attached to the stirring motor arm 4, with both raised upwardly beyond the top edge of the cooking pot 1. FIG. 6 is a top view of the stirring blade 5 in the most preferred embodiment of the present invention attached to the stirring motor arm 4 and located in a substantially horizontally-extending position over a non-tilted cooking pot 1, whereby one end of the stirring blade 5 becomes positioned for mixing food close to the sides of the cooking pot 1 and the other end becomes positioned for mixing food more centrally located within the cooking pot 1. FIG. 7 is a top view of the stirring motor arm 4 in the most preferred embodiment of the present invention having an attached stirring blade 5 and located in a substantially horizontally-extending position over a non-tilted cooking pot 1 which has a collar 8 upwardly-extending beyond its top edge, with the upper edge of the collar 8 tapering inwardly over the lateral portions of the stirring blade 5. FIG. 8 is a bottom view of the heating base 3 in the most preferred embodiment of the present invention having an external tilt mechanism 11 in an extended position and a widened front area 10. FIG. 9 is a side view of the cooking pot 1 in the most preferred embodiment of the present invention in locked association with a heating base 3, a collar 8 upwardly extending beyond the cooking pot's 1 top edge, the stirring motor arm 4 extending in a substantially horizontal position over the cooking pot 1 and the heating base 3 and cooking pot 1 each in a tilted orientation. FIG. 9 also shows power switches 12 and 13, power cord 9, and the pivoting connection 14 of stirring motor arm 4 to base 3. FIG. 10 is a side view of the cooking pot 1 in the most preferred embodiment of the present invention in locked association with a heating base 3, a collar 8 upwardly extending beyond the cooking pot's 1 top edge, the stirring motor arm 4 extending in a substantially horizontal position over the cooking pot 1, and the heating base 3 and cooking pot 1 both in non-tilted orientations.

What is claimed is:

1. An electrical cooking appliance comprising:
a cooking pot having a top edge and interior side surfaces;
a base configured for removable receipt of said cooking pot in a non-tilted orientation, said base also configured for repositioning said cooking pot into at least one tilted orientation, and said base further configured for providing a temporary but user-releasable positive lock between said cooking pot and said base so that said cooking pot remains fixed to said base when said cooking pot is in said at least one tilted orientation, and said base further having the capability of providing heat sufficient for cooking food placed into said cooking pot when said cooking pot is positively locked onto said base;
a drive shaft;
a stirring motor arm with a distal end and a proximal end, said proximal end pivotally connected to said base so that said stirring motor arm is movable between a lowered position where said distal end is close to said base and a raised position, said distal end also configured for receipt and rotation of said drive shaft; and
at least one stirring blade configured for being rotated by said drive shaft, said stirring blade also having opposed ends configured so that at least one of said opposed ends reaches food close to said interior side surfaces of said cooking pot when said at least one stirring blade is connected to said stirring motor arm, said cooking pot is locked onto said base, and said at least one stirring blade extends into said cooking pot.

2. The cooking appliance of claim 1 wherein said at least one stirring blade has one end at least one end configured to reach food close to said interior side surfaces of said cooking pot and a second end configured for positioning more centrally within said cooking pot.

3. The cooking appliance of claim 1 wherein said tilted orientation is a maximum of approximately forty-five degrees from said non-tilted orientation.

4. The cooking appliance of claim 1 further comprising a splash and spill reducing collar configured for association with said top edge of said cooking pot, said collar extending upwardly beyond said top edge, and said collar further having an inwardly-tapering upper edge above stirring blade.

5. The cooking appliance of claim 1 wherein said cooking pot, said at least one stirring blade, and said collar are made from dishwasher safe materials.

6. The cooking appliance of claim 1 further comprising microprocessor control of stirring blade rotation, heat production of said base, and tilting of said base.

7. The cooking appliance of claim 6 wherein said rotation and said heat production are selected from a group consisting of rotation having a delayed start, heat production having a delayed start, rotation and heat production having a delayed start, rotation ceasing at a pre-determined time after food cooking begins, heat production ceasing at a pre-determined time after food cooking begins, rotation and heat production ceasing at a pre-determined time after food cooking begins, rotation and heat production commencing at the same time, rotation and heat production ceasing at the same time, and rotation and heat production operating independently from one another.

8. The cooking appliance of claim 1 further wherein rotation of said stirring blade is selected from a group consisting of comprising an additional cooking pot having a diameter dimension different from that of said cooking pot, and wherein said base is configured to accommodate and securely lock into place one at a time said cooking pot and said additional cooking pot.

9. The cooking appliance of claim 1 wherein tilting of said base is accomplished via members selected from a group consisting of internally-housed tilt mechanisms and externally-housed tilt mechanisms.

10. The cooking appliance of claim 1 wherein said base is configured for repositioning said cooking pot into multiple tilted orientations.

11. The cooking appliance of claim 1 wherein rotation of said stirring blade is selected from a group consisting of adjustable rotation, rotation wherein intermittent stirring occurs and rotation wherein increased frequency of stirring occurs at the end of food preparation when the burning and/or sticking of food being cooked is most likely to occur.

12. The cooking appliance of claim 1 wherein said cooking pot has at least one insulated handle.

13. The cooking appliance of claim 1 wherein said base has a front portion with a widened blunt area that is configured to provide stability when said base is in a tilted orientation.

14. An electrical cooking appliance comprising:
a cooking pot having a top edge and interior side surfaces;
a splash and spill reducing collar configured for association with said top edge of said cooking pot, said collar extending upwardly beyond said top edge, and said collar further having an inwardly-tapering upper edge;
a base configured for removable receipt of said cooking pot in a non-tilted orientation, said base also configured for repositioning said cooking pot into at least one tilted orientation, and said base further configured for providing a temporary but user-releasable positive lock between said cooking pot and said base so that said cooking pot remains fixed to said base when said cooking pot is in said at least one tilted orientation, and said base further having the capability of providing heat sufficient for cooking food placed into said cooking pot when said cooking pot is positively locked onto said base;
a drive shaft;
a stirring motor arm with a distal end and a proximal end, said proximal end pivotally connected to said base so that said stirring motor arm is movable between a lowered position where said distal end is close to said base and a raised position, said distal end also configured for receipt and rotation of said drive shaft; and
a stirring blade configured for connection to said drive shaft and being rotated by said drive shaft, said stirring blade also having opposed ends configured so that the first of said opposed ends reaches food close to said interior side surfaces of said cooking pot and the second of said opposed ends is configured for positioning more centrally within said cooking pot while said stirring blade is connected to said stirring motor arm, said cooking pot is locked onto said base, and said stirring blade extends into said cooking pot, and further so that said an inwardly-tapering upper edge of said collar extends over said opposed ends of said stirring blade to reduce food splashing and spilling particularly in said at least one tilted orientation.

15. The cooking appliance of claim 14 wherein said tilted orientation is a maximum of approximately forty-five degrees from said non-tilted orientation.

16. The cooking appliance of claim 14 further comprising microprocessor control of stirring blade rotation, heat production of said base, and tilting of said base.

17. The cooking appliance of claim 16 wherein said rotation and said heat production are selected from a group consisting of rotation having a delayed start, heat production having a delayed start, rotation and heat production having a delayed start, rotation ceasing at a pre-determined time after food cooking begins, heat production ceasing at a pre-determined time after food cooking begins, rotation and heat production ceasing at a pre-determined time after food cooking begins, rotation and heat production commencing at the same time, rotation and heat production ceasing at the same time, and rotation and heat production operating independently from one another.

18. The cooking appliance of claim 14 further wherein rotation of said stirring blade is selected from a group consisting of comprising an additional cooking pot having a diameter dimension different from that of said cooking pot, and wherein said base is configured to accommodate and securely lock into place one at a time said cooking pot and said additional cooking pot.

19. The cooking appliance of claim 14 wherein tilting of said base is accomplished via members selected from a group consisting of internally-housed tilt mechanisms and externally-housed tilt mechanisms.

20. The cooking appliance of claim 14 wherein said base has a front portion with a widened blunt area that is configured to provide stability when said base is in a tilted orientation.
